(19) United States
(12) Patent Application Publication
(10) Pub. No.: US 2013/0238216 A1
(43) Pub. Date: Sep. 12, 2013

(54) VEHICLE CONTROL APPARATUS AND VEHICLE CONTROL METHOD

(71) Applicants: Kentaro Yamamoto, Kariya-shi (JP); Yukio Mori, Kariya-shi (JP)

(72) Inventors: Kentaro Yamamoto, Kariya-shi (JP); Yukio Mori, Kariya-shi (JP)

(73) Assignee: ADVICS CO., LTD., Kariya-City, Aichi-pref. (JP)

(21) Appl. No.: 13/881,352

(22) PCT Filed: Oct. 28, 2011
(86) PCT No.: PCT/JP2011/074899

§ 371 Date: Apr. 24, 2013

(30) Foreign Application Priority Data
Oct. 29, 2010 (JP) 2010-244774
Oct. 29, 2010 (JP) 2010-244775
Oct. 29, 2010 (JP) 2010-244776

(51) Int. Cl. F02D 35/00

(52) U.S. Cl. CPC F02D 35/00
USPC 701/101

(57) ABSTRACT

Force of depressing operation of a brake pedal is estimated on the basis of an output torque of an internal-combustion engine computed by an engine ECU and acceleration of a vehicle detected by an acceleration sensor. When the estimated force of the depressing operation of the brake pedal is greater than or equal to a second determination value and the amount of depressing operation of an accelerator pedal detected by an accelerator operation amount sensor is greater than or equal to a first determination value, the output torque of the internal-combustion engine is restricted. Accordingly, acceleration and start of the vehicle due to simultaneous depressing of the accelerator pedal and the brake pedal can be restricted without providing a sensor for detecting the amount of the depressing operation of the brake pedal.

### TECHNICAL FIELD

The present invention relates to a vehicle control apparatus and a vehicle control method for restricting drive torque transmitted to an axle in a state in which depressing operation of an accelerator pedal and a brake pedal is simultaneously performed.

### BACKGROUND ART

In recent years, occurrence of events has been reported in which an accelerator pedal and a brake pedal are simultaneously depressed caused by depression of the brake pedal in a state in which the accelerator pedal is caught on a floor mat. In this case, when the amount of the depressing operation of the accelerator pedal is great, the vehicle is accelerated or started even if the brake pedal is depressed by the driver.

Conventionally, Patent Document 1 proposes that, in simultaneous operation of an accelerator pedal and a brake pedal, output of an in-vehicle internal-combustion engine be restricted when the amount of depressing operation of the brake pedal detected by a sensor (or an index value thereof, for example, a brake operation pressure) becomes greater than a determination value. The determination value is set to a value corresponding to an amount of depressing operation of the brake pedal that cannot be normally obtained if both pedals are intentionally depressed by the driver.

Even in a case in which the accelerator pedal and the brake pedal are simultaneously accidentally depressed, if the amount of depressing operation of the brake pedal becomes great, it is recognized that the depressing operation of the accelerator pedal is not intended by the driver. Accordingly, the depressing operation of the brake pedal is given priority so that the output of the in-vehicle internal-combustion engine is restricted. As a result, the acceleration and the start of the vehicle due to simultaneous depression of the accelerator pedal and the brake pedal are restricted.

### PRIOR ART DOCUMENT

### Patent Document

Patent Document 1: Japanese Laid-Open Patent Publication No. 2005-291030

### SUMMARY OF THE INVENTION

### Problems that the Invention is to Solve

To reduce manufacturing costs of a vehicle, elimination of the sensor that detects the amount of depressing operation of the brake pedal has been considered. In this case, if the sensor is merely eliminated, the amount of depressing operation of the brake pedal at each point in time cannot be determined. Accordingly, the above described acceleration and the start of the vehicle due to simultaneous depressing of the accelerator pedal and the brake pedal cannot be restricted.

An object of the present invention is to provide a vehicle control apparatus and a vehicle control method that highly accurately restrict acceleration and start of a vehicle due to simultaneous depressing of an accelerator pedal and a brake pedal without providing a sensor for detecting an amount of depressing operation of the brake pedal.

### Means for Solving the Problems

A vehicle control apparatus of the present invention is applied to a vehicle including an internal-combustion engine as a driving source, an acceleration sensor, and an accelerator operation amount sensor. The acceleration sensor detects vehicle acceleration, and the accelerator operation amount sensor detects an amount of a depressing operation of an accelerator pedal. The vehicle control apparatus includes: an output computing section, which computes an output torque of the internal-combustion engine; a depressing force estimating section, which estimates a force of a depressing operation of a brake pedal of the vehicle on the basis of the vehicle acceleration detected by the acceleration sensor and the output torque computed by the output computing section; and a torque restricting section, which restricts a driving torque transmitted from the internal-combustion engine to an axle of the vehicle when the amount of the depressing operation of the accelerator pedal detected by the accelerator operation amount sensor is greater than or equal to a first determination value and the force of the depressing operation of the brake pedal estimated by the depressing force estimating section is greater than or equal to a second determination value.

According to the above described configuration, the actual acceleration of the vehicle is detected by the acceleration sensor and the acceleration of the vehicle obtained by the operation of the internal-combustion engine (engine-derived acceleration) is determined on the basis of the output torque of the internal-combustion engine. Therefore, changes in the acceleration of the vehicle by the depressing operation of the brake pedal is determined on the basis of a relationship between the sensor-detected acceleration and the engine-derived acceleration, and thus force of depressing operation (depressing force) of the brake pedal is estimated with high accuracy on the basis of the changes in the acceleration. It is determined that the depressing force of the brake pedal is greater than or equal to the second determination value on the basis of an estimated value (brake pedal depressing force estimated value) with high accuracy. Accordingly, on the basis of the determination according to the brake pedal depressing force estimated value and the determination that the amount of depressing operation of the accelerator pedal detected by the accelerator operation amount sensor is greater than or equal to the first determination value, the simultaneous depressing of the accelerator pedal and the brake pedal is determined with high accuracy to restrict the driving torque transmitted from the internal-combustion engine to an axle precisely. Accordingly, acceleration and start of the vehicle due to the simultaneous depressing of the accelerator pedal and the brake pedal is restricted without providing a sensor for detecting an amount of the depressing operation of the brake pedal.

In the vehicle control of the present invention, it is preferable that the vehicle includes a brake booster, which assists the depressing operation of the brake pedal by a booster negative pressure generated using an intake air negative pressure produced by the internal-combustion engine, and the depressing force estimating section estimates the force of the depressing operation of the brake pedal using the booster negative pressure as an estimation parameter.

Brake boosters, which assist depressing operation of brake pedals by booster negative pressure generated using an intake air negative pressure of the internal-combustion engine, are commonly provided in vehicles. The brake booster is configured such that the booster negative pressure approaches the atmospheric pressure when the depressing operation of the brake pedal is being performed. Accordingly, when the depressing operation of the brake pedal is repeatedly performed in a short time, the booster negative pressure is almost lost (substantially the same as the atmospheric air pressure) to cause a situation in which the brake pedal is depressed in the state in which there is almost no assistance by the brake booster so that the degree of deceleration of the vehicle by the depressing operation of the brake pedal is reduced. As a result, the relationship among the actual depressing force of the brake pedal, the output torque of the internal-combustion engine, and the sensor-detected acceleration of the vehicle is changed. This reduces the accuracy of estimation of an index value of the brake depressing force estimated by the above described depressing force estimating section.

In this regard, according to the above described configuration, since the brake depressing force estimated value is computed using the booster negative pressure as one of estimation parameters, the brake depressing force estimated value is computed with high accuracy in consideration of influences of changes in the booster negative pressure.

In the vehicle control apparatus of the present invention, it is preferable that the vehicle includes a brake switch, which detects presence or absence of the depressing operation of the brake pedal, and the vehicle control apparatus further includes a changing section, which changes the second determination value to be smaller when a frequency of performing the depressing operation of the brake pedal detected by the brake switch is greater than or equal to a third determination value.

According to the above described configuration, when the depressing operation of the brake pedal is repeatedly performed in a short time, namely, when the booster negative pressure is small, in comparison to a case in which the booster negative pressure is not small, the restriction of the driving torque is permitted in a state in which the brake depressing force estimated value is small. Accordingly, although the degree of the deceleration of the vehicle at this time becomes small so that the above described brake depressing force estimated value becomes small, a condition for performing the restriction of the driving torque is changed in accordance with the degree so that the restriction of the driving torque of the vehicle is reliably performed.

In the vehicle control apparatus of the present invention, it is preferable that the depressing force estimating section estimates the force of the depressing operation of the brake pedal using the weight of the vehicle as an estimation parameter.

Even if the brake pedal is depressed by the same force, the actual degree of actual deceleration of the vehicle differs in accordance with the weight of the vehicle. Therefore, it is understood that the relationship among the actual depressing force of the brake pedal, the output torque of the internal-combustion engine, and the sensor-detected acceleration of the vehicle is changed in accordance with the weight of the vehicle. The weight of the vehicle changes in accordance with the weight of loads put on the vehicle, residue of fuel of the internal-combustion engine, the number of passengers, and the like. Accordingly, the changes in the weight of the vehicle lead reduction of accuracy of estimation of the estimated value of the brake depressing force estimated by the above described depressing force estimating section.

As for this, according to the above described configuration, since the brake depressing force estimated value is estimated using the weight of the vehicle as one of computation parameters, the brake depressing force estimated value is estimated with high accuracy in consideration of effects of changes in the weight of the vehicle.

In the vehicle control apparatus of the present invention, when the vehicle includes a pressure sensor, which detects the booster negative pressure, it is preferable that the depressing force estimating section can use the booster negative pressure detected by the pressure sensor as the estimation parameter of the depressing operation.

In the vehicle control apparatus of the present invention, it is preferable that the apparatus includes a weight computing section, which computes the weight of the vehicle on the basis of the vehicle acceleration detected by the acceleration sensor and the output torque computed by the output computing section. In this case, it is preferable that the depressing force estimating section uses the weight computed by the weight computing section as the estimation parameter.

According to the above described configuration, the weight [m] of the vehicle is computed with high accuracy from a motion equation [F=ma] on the basis of the actual acceleration [a] of the vehicle detected by the acceleration sensor and the output torque of the internal-combustion engine computed by the output computing section, namely force [F] applied to the vehicle to run the vehicle.

The vehicle control apparatus of the present invention may includes a correction value computing section, which computes a pitching correction value in accordance with changes in the posture of the vehicle due to a pitching phenomenon. In this case, the depressing force estimating section estimates the force of the depressing operation of the brake pedal on the basis of, in addition to the vehicle acceleration and the output torque, the pitching correction value computed by the correction value computing section.

According to the above described configuration, when there is a difference between the actual acceleration of the vehicle in the running direction and the sensor-detected acceleration detected by the acceleration sensor by the changes in posture of the vehicle due to the occurrence of the pitching phenomenon, the estimated value of the depressing force of the brake pedal (brake pedal depressing force estimated value) can be corrected by the pitching correction value. Therefore, the above described brake pedal depressing force estimated value is estimated with high accuracy, while restricting the reduction of the accuracy of the estimation due to the occurrence of the pitching phenomenon.

In the vehicle control apparatus of the present invention, it is preferable that the vehicle includes a speed sensor, which detects a running speed of the vehicle, and the correction value computing section computes the pitching correction value on the basis of changes in the running speed of the vehicle detected by the speed sensor during running of the vehicle.

The pitching phenomenon during running of the vehicle occurs in accordance with changes in the running speed of the vehicle. The greater the amount of the changes in the running speed of the vehicle is, the greater the changes in the posture of the vehicle are when the pitching phenomenon occurs. From this, it is understood that, during running of the vehicle, changes in the posture of the vehicle due to the occurrence of the pitching phenomenon can be determined on the basis of the changes in the running speed of the vehicle in the running direction (direction parallel to a road surface when running on a flat road).

According to the above described configuration, during the running of the vehicle, the pitching correction value is computed on the basis of the changes in the running speed of the vehicle detected by the speed sensor, namely, a value correlated with the above described changes in the posture. Therefore, according to the pitching correction value, the brake pedal depressing force estimated value is computed with high accuracy, while restricting reduction of the accuracy of estimation due to the above described changes in the posture.

In the vehicle control apparatus of the present invention, the vehicle acceleration computed on the basis of the running speed of the vehicle detected by the speed sensor may be used as the changes in the running speed of the vehicle.

In the vehicle control apparatus of the present invention, it is preferable that the correction value computing section computes the pitching correction value on the basis of the driving torque transmitted to the axle during stop of the vehicle.

The pitching phenomenon when the vehicle stops occurs by driving torque transmitted to the axle. The greater the driving torque is, the greater the changes in the posture of the vehicle at the occurrence of the pitching phenomenon are. From this, it is understood that, when the vehicle stops, the changes in the posture of the vehicle due to the occurrence of the pitching phenomenon are determined on the basis of the driving torque transmitted to the axle.

According to the above described configuration, during the stop of the vehicle, the pitching correction value is computed on the basis of the driving torque transmitted to the axle, namely, a value correlated with the above described changes in the posture. Therefore, according to the pitching correction value, the brake pedal depressing force estimated value is computed with high accuracy, while restricting reduction of the accuracy of estimation due to the above described changes in the posture.

In the vehicle control apparatus of the present invention, the driving torque transmitted to the axle is computed on the basis of the output torque computed by the output computing section.

The vehicle control apparatus of the present invention may include a restriction inhibiting section, which determines whether or not a slip of the vehicle has been generated and inhibits restriction of the driving torque by the torque restricting section when determining that the slip has been generated.

According to the above described configuration, when slip of the vehicle occurs, namely, when the relationship among the sensor-detected acceleration of the vehicle, the engine-derived acceleration, and the depressing force of the brake pedal changes, it is determined that the accuracy of the estimation of the above described brake pedal depressing force estimated value is low. Accordingly, the driving torque is not restricted even through the brake pedal depressing force estimated value is high.

According to an aspect of the present invention, the vehicle includes a drive wheel to which the output torque of the internal-combustion engine is transmitted and a coasting wheel to which the output torque is not transmitted. In this case, it is preferable that the vehicle control apparatus includes a speed difference computing section, which computes a difference of rotation speed of the drive wheel and rotation speed of the coasting wheel, and the restriction inhibiting section permits the restriction of the driving torque by the torque restricting section when the difference of the rotation speed computed by the speed difference computing section is greater than or equal to a third determination value.

In the vehicle including drive wheels and coasting wheels, the output torque of the internal-combustion engine is transmitted to only the drive wheels, while the braking force by the depressing operation of the brake pedal is applied to both of the drive wheels and the coasting wheels. Accordingly, when the slip occurs at the time of the simultaneous operation of the brake pedal and the accelerator pedal in such a vehicle, a difference between the rotation speed of the drive wheels and the rotation speed of the coasting wheels becomes greater. The higher the amount of depressing operation of the accelerator pedal is, the greater the difference of the rotation speed becomes.

According to the above configuration, even if the accuracy of the estimation of the brake pedal depressing force estimated value is low because of slipping of the vehicle, when the difference between the rotation speed of the drive wheels and the rotation speed of the coasting wheels of the vehicle is great, the restriction of the driving torque transmitted from the internal-combustion engine to the axle is performed since it is determined that the acceleration and the start of the vehicle is caused due to a fact that the amount of the depressing operation of the accelerator pedal is great. Therefore, the acceleration and the start of the vehicle due to the simultaneous depressing of both of the pedals are restricted more reliably.

In the vehicle control apparatus of the present invention, it is preferable that the speed difference computing section computes a value obtained by subtracting the rotation speed of the coasting wheel from the rotation speed of the drive wheel as the difference of the rotation speed.

According to the above described configuration, on the basis of the difference of the rotation speed computed by the speed difference computing section, it is precisely determined that the rotation speed of the coasting wheels is higher than the rotation speed of the drive wheels due to the simultaneous operation of the brake pedal and the accelerator pedal and the difference of the rotation speed is high, namely, the acceleration and the start of the vehicle due to the simultaneous operation of both of the pedals and may be caused.

In the vehicle control apparatus of the present invention, it is determined that the slip has been generated when a difference of rotation speed of two wheels of the vehicle is greater than or equal to a fourth determination value.

A method of the present invention for controlling a vehicle including an internal-combustion engine as a driving source, an acceleration sensor, which detects vehicle acceleration, and an accelerator operation amount sensor, which detects an amount of a depressing operation of an accelerator pedal includes the steps of: computing an output torque of the internal-combustion engine; estimating a force of a depressing operation of a brake pedal of the vehicle on the basis of the vehicle acceleration detected by the acceleration sensor and the output torque computed by the step of computing the output torque; and restricting a driving torque transmitted from the internal-combustion engine to an axle of the vehicle when the amount of the depressing operation of the accelerator pedal detected by the accelerator operation amount sensor is greater than or equal to a first determination value and the force of the depressing operation of the brake pedal estimated in the step of estimating the force of the depressing operation of the brake pedal is greater than or equal to a second determination value.

According to the above described vehicle control method, advantages similar to those of the above described vehicle control apparatus are obtained.

### BRIEF DESCRIPTION OF THE DRAWINGS

FIG. 1 is a schematic diagram showing a general configuration of a vehicle according to a first embodiment of the present invention;

FIG. 2 is a cross-sectional view illustrating a cross-sectional configuration of a brake booster;

FIG. 3 is an explanatory view showing a detection error of vehicle acceleration caused by a pitching phenomenon;

FIG. 4 is a flowchart showing execution processes of torque restriction according to the first embodiment;

FIG. 5 is a flowchart showing execution processes of the torque restriction;

FIG. 6 is a flowchart showing execution processes of torque restriction according to a second embodiment; and

FIG. 7 is a flowchart showing execution processes of torque restriction according to a third embodiment.

### MODES FOR CARRYING OUT THE INVENTION

### First Embodiment

A vehicle control apparatus according to a first embodiment of the present invention will now be described.

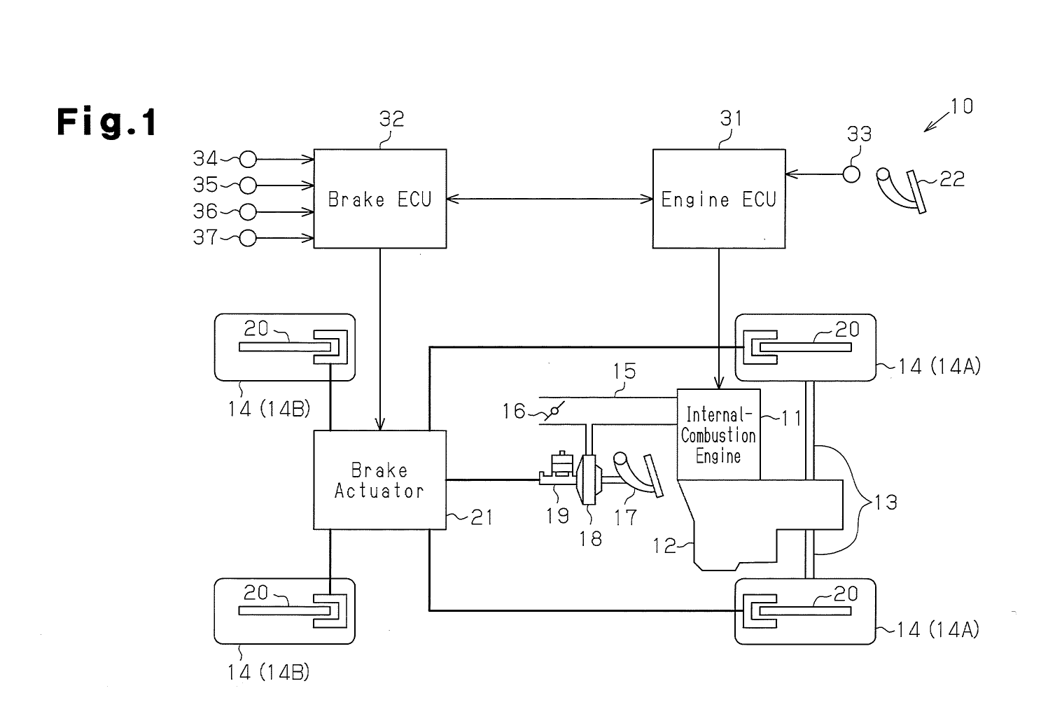

As shown in FIG. 1, an internal-combustion engine 11 as a driving source is mounted on a vehicle 10. An output torque of the internal-combustion engine 11 is transmitted to wheels 14 via a multistage automatic transmission 12 with a plurality of gears and an axle 13. The vehicle 10 is a front-wheel-drive vehicle, in which front ones of the wheels 14 function as drive wheels 14A, to which the output torque of the internal-combustion engine 11 is transmitted, and rear ones of the wheels 14 function as coasting wheels 14B, to which the output torque is not transmitted.

The vehicle 10 has a brake booster 18, which doubles and transmits depressing operation force (depressing force) of a brake pedal 17 using an intake air negative pressure generated downstream a throttle valve 16 in an intake air passage 15 of the internal-combustion engine 11. Further, the vehicle 10 is equipped with a master cylinder 19, which generates a brake fluid pressure (master cylinder pressure) according to the depressing force of the brake pedal 17 doubled by the brake booster 18. Moreover, the vehicle 10 has a brake actuator 21, which operates to give braking force to a disc brake gear 20 provided in each of the wheels 14 according to the brake fluid pressure generated by the master cylinder 19.

Furthermore, the vehicle 10 includes an electronic control unit (engine ECU 31), which controls the operations of the internal-combustion engine 11, and an electronic control unit (brake ECU 32), which controls the operation of the brake actuator 21. The engine ECU 31 functions as an output computing section. The brake ECU 32 functions as a depressing force estimating section, a torque restricting section, a weight computing section, a correction value computing section, and a restriction prohibition section.

The engine ECU 31 and the brake ECU 32 receive detection signals from a sensor and a switch, which detect the operating state of the vehicle 10. For example, the engine ECU 31 receives detection signals from an accelerator operation amount sensor 33, which detects an amount of depressing operation of the accelerator pedal 22 (accelerator depression amount Othr). Further, the brake ECU 32 receives detection signals from an acceleration sensor 34, which detects acceleration (sensor-detected acceleration G) that acts in the front-back direction of the vehicle 10, and signals from a brake switch 35, which detects whether or not the brake pedal 17 is depressed on. Moreover, the brake ECU 32 receives detection signals from speed sensors 36, which detect rotation speed (wheel speed VSO) of the wheels 14, and detection signals from a pressure sensor 37, which detects a negative pressure (booster negative pressure Pv) generated inside the brake booster 18.

As the above described acceleration sensor 34, a sensor with a single detection axis (more specifically, in a direction in which acceleration is detected with high accuracy) is adopted. The acceleration sensor 34 is attached to the vehicle 10 such that the detection axis corresponds to a running direction (more specifically, the front-back direction) of the vehicle 10. Further, the speed sensors 36 are each provided in the vicinity of one of the wheels 14 to detect the rotation speed (wheel speed VSO) of the corresponding wheel 14. The rotation speed (wheel speed VSO) of each wheel 14 is correlated with the running speed (vehicle body speed) of the vehicle 10. Accordingly, it is also understood that each speed sensor 36 is a sensor that detects the running speed (vehicle body speed) of the vehicle 10.

Various types of information are communicated between the engine ECU 31 and the brake ECU 32 through data communications. The data includes a gear ratio (gear position Pgear) selected in the automatic transmission 12 and an output torque (engine torque Teng) of the internal-combustion engine 11 determined on the basis of the operating state of the internal-combustion engine 11 as well as the information detected by the sensor and the switch. The engine torque Teng is obtained by computation from a degree of opening of the throttle valve 16, for example.

The engine ECU 31 performs an operation control of the internal-combustion engine 11 in accordance with the operating state of the vehicle 10 determined from a detection result of each type of the sensor and the switch. Further, the brake ECU 32 operates a control solenoid of the brake actuator 21 to perform control operation of a brake system such as anti-lock brake system (ABS), brake assistance, and electronic stability control (ESC).

The configuration of the brake booster 18 will now be described in detail.

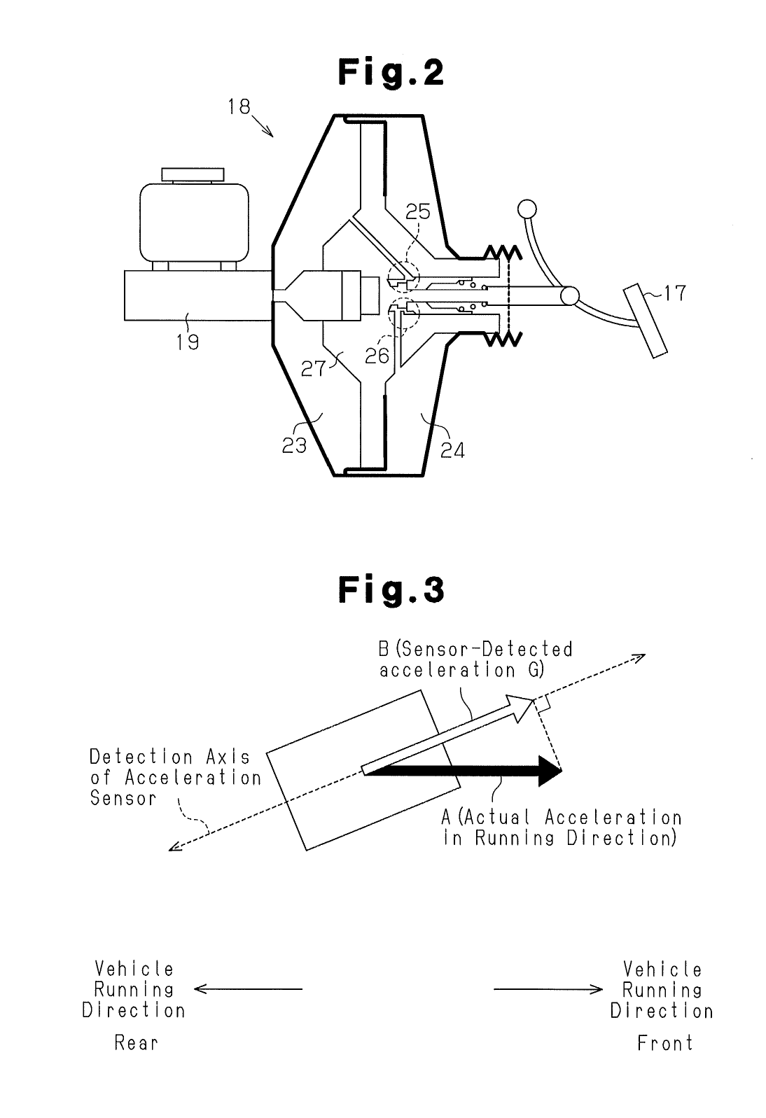

As shown in FIG. 2, two pressure chambers, namely, a constant-pressure chamber 23 and a pressure change chamber 24 are defined inside the brake booster 18. The constant-pressure chamber 23 of these chambers is in communication with the intake air passage 15 (refer to FIG. 1) of the internal-combustion engine 11 via a check valve, which is not illustrated, so that negative pressure (specifically, pressure lower than atmospheric pressure) is introduced into the constant-pressure chamber 23 by the intake air negative pressure. The booster negative pressure of the brake booster 18 is a negative pressure (differential pressure between the atmospheric air pressure and the pressure in the constant-pressure chamber 23) in the constant-pressure chamber 23.

Further, two valves, namely, a vacuum valve 25 and an atmospheric air valve 26 are provided in the brake booster 18. When the vacuum valve 25 is opened, the constant-pressure chamber 23 is in communication with the pressure change chamber 24. In contrast, when the vacuum valve 25 is closed, the communication between the constant-pressure chamber 23 and the pressure change chamber 24 is interrupted. When the atmospheric air valve 26 is opened, the pressure change chamber 24 is open to the atmospheric air.

Further, a piston 27 is located inside the brake booster 18. The constant-pressure chamber 23 is separated from the pressure change chamber 24 by the piston 27. The piston 27 is coupled with the brake pedal 17 and located in a state in which it can move according to the depressing operation of the brake pedal 17.

When the depressing operation of the brake pedal 17 is not performed (when the brake is not operated), the vacuum valve 25 is configured to be opened, while the atmospheric air valve 26 is configured to be closed. At this time, the constant-pressure chamber 23 and the pressure change chamber 24 are in communication with each other so that the intake air negative pressure of the internal-combustion engine 11 is introduced into the chambers 23 and 24. Accordingly, the pressure in the constant-pressure chamber 23 and the pressure in the pressure change chamber 24 are substantially equal to each other.

In contrast, when the depressing operation of the brake pedal 17 is being performed (when the brake is operated), the vacuum valve 25 is configured to be closed, while the atmospheric air valve 26 is configured to be opened. At this time, the communication between the constant-pressure chamber 23 and the pressure change chamber 24 is interrupted and an internal pressure in the pressure change chamber 24 gradually approaches the atmospheric air pressure so that the pressure in the constant-pressure chamber 23 becomes greater than the pressure in the pressure change chamber 24. The piston 27 is pressed by the pressure difference between the pressure in the constant-pressure chamber 23 and the pressure in the pressure change chamber 24 to assist the depressing operation of the brake pedal 17.

The vehicle 10 includes a system (brake override system, or BOS), which controls the output of the internal-combustion engine 11 to restrict the acceleration and the start of the vehicle 10 caused when the brake pedal 17 and the accelerator pedal 22 are erroneously simultaneously depressed. In this system, the output torque of the internal-combustion engine 11 is restricted when the accelerator depression amount Othr is greater than or equal to a first determination value α and the depressing force (a estimated value of the master cylinder pressure [master pressure estimated value PesPm, which will be described below]) of the brake pedal 17 is greater than or equal to a second determination value β. Thereby, the acceleration and the start of the vehicle 10 caused by simultaneously depression of the brake pedal 17 and the accelerator pedal 22 are restricted.

In the above described vehicle 10, a sensor, which detects the depressing force of the brake pedal 17, is omitted to reduce the manufacturing costs. In this case, when the sensor is merely omitted, the depressing force of the brake pedal 17 at each point in time cannot be determined. Accordingly, the above described acceleration and the start of the vehicle 10 due to the simultaneous depressing of the brake pedal 17 and the accelerator pedal 22 cannot be restricted by the BOS.

Accordingly, in the present embodiment, the depressing force of the brake pedal 17 is estimated on the basis of the output torque (the engine torque Teng) of the internal-combustion engine 11 computed by the engine ECU 31 and the sensor-detected acceleration G detected by the acceleration sensor 34. The restriction of the output of the internal-combustion engine 11 is performed by the brake ECU 32 on the basis of the estimated value (more specifically, the master pressure estimated value PesPm, which will be described below).

As is clear from the fact that the vehicle 10 is decelerated by the depressing operation of the brake pedal 17, the depressing force of the brake pedal 17 is correlated with the acceleration of the vehicle 10. In consideration of this, in the present embodiment, the master pressure estimated value PesPm is computed on the basis of the sensor-detected acceleration G detected by the acceleration sensor 34 and the master pressure estimated value PesPm is used in the above described BOS.

Specifically, the computation of the master pressure estimated value PesPm is performed on the basis of the following considerations. First, the sensor-detected acceleration G of the vehicle 10 is detected by the acceleration sensor 34 and the acceleration of the vehicle 10 (engine-derived acceleration) obtained by the operation of the internal-combustion engine 11 is determined on the basis of the engine torque Teng. The changes in the acceleration of the vehicle 10 by the depressing operation of the brake pedal 17 are determined on the basis of relationship between the sensor-detected acceleration G and the engine-derived acceleration. Further, the above described master pressure estimated value PesPm is computed by converting the changes in the acceleration into the depressing force of the brake pedal 17 according to conversion coefficient determined by characteristics of the vehicle 10.

According to the present embodiment, it can be determined that the depressing force of the brake pedal 17 is greater than or equal to the second determination value β on the basis of the master pressure estimated value PesPm with high accuracy. According to the determination on the basis of the master pressure estimated value PesPm and the determination that the accelerator depression amount Othr detected by the accelerator operation amount sensor 33 is greater than or equal to the first determination value α, the simultaneous depressing of the brake pedal 17 and the accelerator pedal 22 is determined with high accuracy to restrict the output of the internal-combustion engine 11 precisely. Accordingly, the acceleration and the start of the vehicle 10 due to the simultaneous depressing of the brake pedal 17 and the accelerator pedal 22 can be restricted without providing a sensor for detecting the amount of depressing operation of the brake pedal 17.

The brake booster 18 is configured such that the booster negative pressure approaches the atmospheric pressure when the depressing operation of the brake pedal 17 is being performed. Accordingly, when the depressing operation of the brake pedal 17 is repeatedly performed in a short time, the booster negative pressure is almost lost (substantially the same as the atmospheric air pressure) to cause a situation in which the brake pedal 17 is depressed in the state in which there is almost no assistance by the brake booster 18. In this case, the degree of deceleration of the vehicle 10 by the depressing operation of the brake pedal 17 is reduced so that the relationship among the actual depressing force of the brake pedal 17, the output torque (engine torque Teng) of the internal-combustion engine 11, and the sensor-detected acceleration G of the vehicle 10 is changed to cause reduction of accuracy of estimating the above described master pressure estimated value PesPm.

In consideration of this, in the present embodiment, the booster negative pressure Pv detected by the pressure sensor 37 is used as one of estimation parameters for the master pressure estimated value PesPm. Thereby, the master pressure estimated value PesPm can be computed with high accuracy in consideration of effects by the changes in the booster negative pressure Pv.

Further, even if the brake pedal 17 is depressed by the same force, the actual degree of deceleration of the vehicle 10 differs in accordance with the weight of the vehicle 10. Therefore, in accordance with the weight of the vehicle 10, it is understood that the relationship among the actual depressing force of the brake pedal 17, the output torque (engine torque Teng) of the internal-combustion engine 11, and the sensor-detected acceleration G of the vehicle 10 is changed. Also, the weight of the vehicle changes in accordance with the weight of loads put on the vehicle 10, residue of fuel of the internal-combustion engine 11, the number of passengers, and the like. Accordingly, the changes in the weight of the vehicle 10 may cause reduction of the accuracy of the estimation of the master pressure estimated value PesPm.

Therefore, in the present embodiment, the weight of the vehicle 10 is estimated and an estimated value thereof (load estimated value PesW, which will be described below) is used as one of estimation parameters for the master pressure estimated value PesPm. Thereby, the above described master pressure estimated value PesPm can be estimated with high accuracy in consideration of effects by the changes in the weight of the vehicle 10.

Further, when the master pressure estimated value PesPm is computed on the basis of the sensor-detected acceleration G detected by the acceleration sensor 34 and the master pressure estimated value PesPm is used in the above described BOS as in the present embodiment, the following disadvantage may be caused.

According to the present embodiment, the acceleration sensor 34 is attached to the vehicle 10 such that the detection axis of the acceleration sensor 34 matches with the front-back direction of the vehicle 10. When the vehicle 10 runs, a phenomenon (what is called a pitching phenomenon) in which a vehicle front section sinks with respect to a vehicle rear section or the vehicle rear section sinks with respect to the vehicle front section in accordance with the changes in running speed may be caused. When such a pitching phenomenon is caused, since the posture of the vehicle 10 with respect to a running road surface changes, the posture of the acceleration sensor 34 attached to the vehicle 10 also changes.

Accordingly, as shown in FIG. 3, at this time, the detection axis of the acceleration sensor 34 is shifted with respect to the running direction (more specifically, a direction in parallel with a road surface when running on a flat road surface) of the vehicle 10 so that the actual acceleration (the value shown by arrow A in FIG. 3) in the running direction of the vehicle 10 is shifted with respect to the sensor-detected acceleration G (the value shown by arrow B in FIG. 3) detected by the acceleration sensor 34. FIG. 3 shows an example of relationship between the actual acceleration in the running direction of the vehicle and the sensor-detected acceleration G in a state in which the vehicle rear section sinks with respect to the vehicle front section. As is clear from FIG. 3, when the pitching phenomenon occurs, the sensor-detected acceleration G detected by the acceleration sensor 34 is smaller than the actual acceleration in the running direction of the vehicle. The changes in the detection value (sensor-detected acceleration G) of the acceleration sensor 34 caused by the occurrence of such a pitching phenomenon cause reduction of accuracy of computation when the master pressure estimated value PesPm is computed on the basis of the sensor-detected acceleration G as described above. FIG. 3 exaggerates a gap between the detection axis of the acceleration sensor 34 and the running direction of the vehicle 10 for easy understanding of the changes in the sensor-detected acceleration G.

In consideration of this, in the present embodiment, a correction value (pitching correction value Gp) in accordance with changes in the posture of the vehicle 10 due to the pitching phenomenon is computed and the pitching correction value Gp is used as one of estimation parameters for the above described master pressure estimated value PesPm.

According to the present embodiment, the pitching correction value Gp is computed in different manners at the time of running of the vehicle 10 and at the time of stopping of the vehicle 10. Hereinafter, a mode of computing such a pitching correction value Gp will now be described.

First, the mode of computing the pitching correction value Gp at the time of running the vehicle 10 will now be described.

The pitching phenomenon during the running of the vehicle 10 occurs in accordance with changes in the running speed of the vehicle 10. The greater the amount of the changes in the running speed of the vehicle 10 is, the greater the changes in the posture of the vehicle 10 are when the pitching phenomenon occurs. From this, during the running of the vehicle 10, it is understood that the changes in the posture of the vehicle 10 due to the occurrence of the pitching phenomenon can be determined on the basis of the changes in the running speed of the vehicle 10 in the running direction.

Therefore, in the preset embodiment, during the running of the vehicle 10, the above described pitching correction value Gp is computed on the basis of the changes (more specifically, the acceleration [estimated vehicle body acceleration ΔVref, which will be described below] of the vehicle 10 estimated on the basis of the wheel speed VSO detected by each speed sensor 36) in the running speed of the vehicle 10 in the running direction.

Thereby, during the running of the vehicle 10, the pitching correction value Gp can be computed on the basis of the changes in the running speed of the vehicle 10 detected by the speed sensor 36, namely, a value correlated with the changes in the posture of the vehicle 10 due to the pitching phenomenon. According to the pitching correction value Gp, the master pressure estimated value PesPm can be computed with high accuracy, while restricting reduction of the accuracy of estimation due to the above described changes in the posture.

Next, a mode of computing the pitching correction value Gp when the vehicle 10 stops will now be described below.

The pitching phenomenon when the vehicle 10 stops occurs by driving torque transmitted from the internal-combustion engine 11 to the axle 13. The greater the driving torque is, the greater the changes in the posture of the vehicle 10 at the occurrence of the pitching phenomenon become. From this, when the vehicle 10 stops, it is understood that the changes in the posture of the vehicle 10 due to the occurrence of the pitching phenomenon can be determined on the basis of the driving torque transmitted to the axle 13.

In consideration of this, in the present embodiment, when the vehicle 10 stops, the pitching correction value Gp is computed on the basis of the driving torque transmitted to the axle 13. The above described driving torque can be computed on the basis of the output torque (engine torque Teng) of the internal-combustion engine 11, gear ratio Rtgear of the automatic transmission 12 computed on the basis of the gear position Pgear, and gear ratio Rfinal of the final gear provided in the automatic transmission 12.

Thereby, when the vehicle 10 stops, the pitching correction value Gp can be computed on the basis of the driving torque transmitted to the axle 13, namely, a value correlated with the changes in the posture of the vehicle 10 due to the pitching phenomenon. According to the pitching correction value Gp, the master pressure estimated value PesPm can be computed with high accuracy, while restricting reduction of the accuracy of estimation due to the above described changes in the posture.

Accordingly, in the present embodiment, even if there is a difference between the actual acceleration of the vehicle 10 in the running direction and the sensor-detected acceleration G detected by the acceleration sensor 34 by the changes in the posture of the vehicle 10 due to the occurrence of the pitching phenomenon, the master pressure estimated value PesPm can be estimated with high accuracy via correction of the value (pitching correction value Gp) in accordance with the changes in the posture of the vehicle 10.

Further, as well as the above described disadvantages due to the occurrence of the pitching phenomenon, the following disadvantages may be caused. When the vehicle 10 runs a road surface with a low coefficient of friction (for example, frozen road) or when the driving torque transmitted to the axle 13 is high because of a large amount of depressing operation of the accelerator pedal 22, the wheels 14 may slip. When such slip occurs, the driving state (more specifically, the relationship among the engine torque Teng, the sensor-detected acceleration G, and the depressing force of the brake pedal 17) of the vehicle 10 changes in accordance with the slip. The changes in the driving state of the vehicle 10 due to presence or absence of the slip is one of reasons of reduction in the accuracy of estimating the master pressure estimated value PesPm in a device for computing the master pressure estimated value PesPm on the basis of the driving state of the vehicle 10 as the apparatus according to the present embodiment.

Accordingly, in the present embodiment, the occurrence of slip of the vehicle 10 is determined. When it is determined that slip has occurred, the restriction of the output of the internal-combustion engine 11 by the BOS is inhibited. Accordingly, when the slip of the vehicle 10 has occurred, namely, when the relationship among the engine torque Teng, the sensor-detected acceleration G, and the depressing force of the brake pedal 17 changes, it is determined that the accuracy of the estimation of the master pressure estimated value PesPm is low. Accordingly, restriction of the output of the internal-combustion engine 11 is not executed even if the master pressure estimated value PesPm is high.

Hereinafter, a process (torque restriction process) for restricting the output torque of the internal-combustion engine 11 by the BOS will be described in detail.

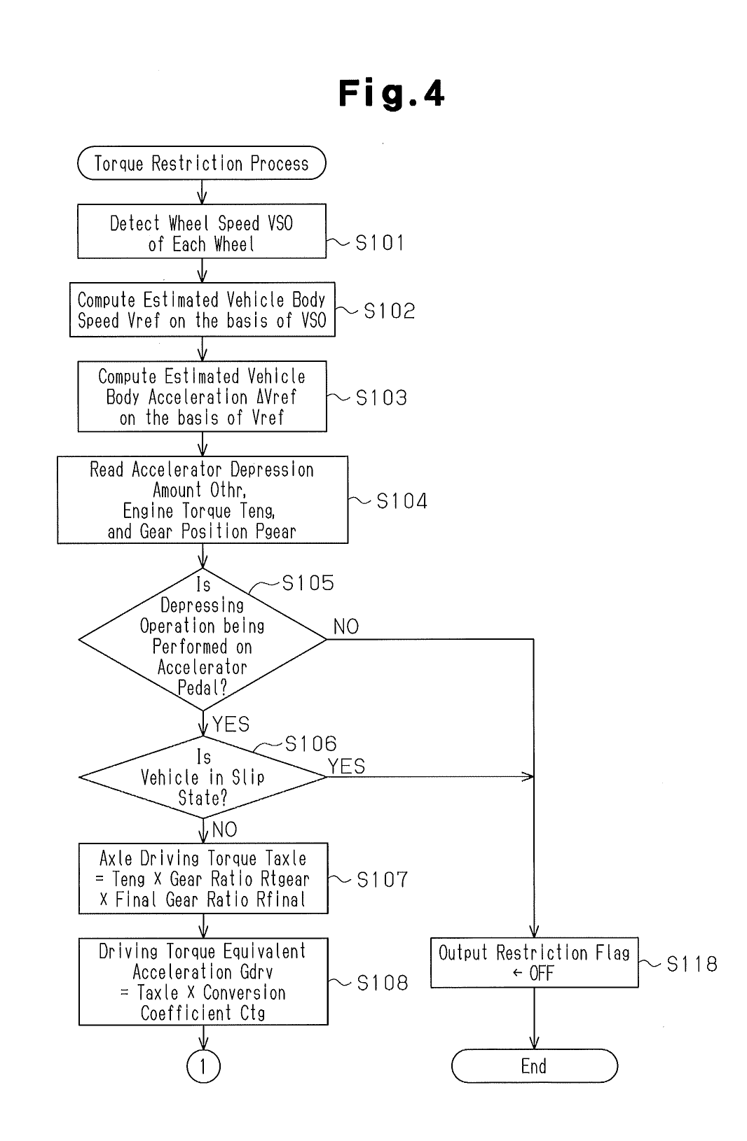

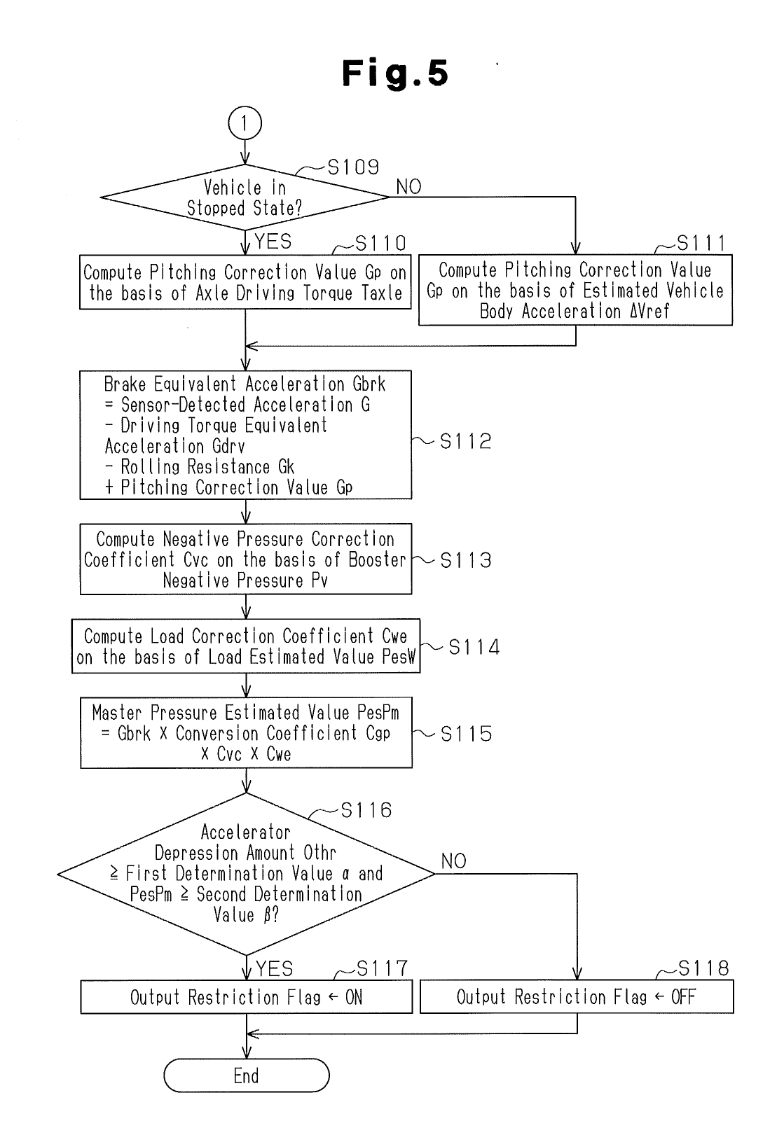

FIGS. 4 and 5 are flowcharts showing specific steps of the above described torque restriction process. A series of the steps shown in the flowcharts is executed by the brake ECU 32 for every predetermined time (for example, several milliseconds) under a condition in that the brake switch 35 is turned on.

As shown in FIG. 4, in this process, wheel speed VSO of each wheel 14 is first detected by the speed sensor 36 (Step S101).

Then, an estimated value (estimated vehicle body speed Vref) on the running speed of the vehicle 10 is computed on the basis of each wheel speed VSO (Step S102). Specifically, the value that shows the highest speed of four of the wheel speeds VSO is computed as the estimated vehicle body speed Vref. The estimated vehicle body speed Vref is not a value showing the vehicle body speed itself but a value showing rotation speed of the wheel 14 correlated with the vehicle body speed.

Further, an estimated value (estimated vehicle body acceleration ΔVref) on the acceleration of the vehicle 10 is computed on the basis of the estimated vehicle body speed Vref (Step S103). Specifically, a difference (Vref[i]−Vref[i−1]) between the estimated vehicle body speed Vref[i−1] at the previous execution of the step and the estimated vehicle body speed Vref[i] at the current execution of the step is computed as the estimated vehicle body acceleration ΔVref.

The accelerator depression amount Othr, the engine torque Teng, and the gear position Pgear, which are detected (or computed) and stored by the engine ECU 31, are read out (Step S104). In the present embodiment, the process of step S104 corresponds to an output computing step.

Thereafter, it is determined whether or not the depressing operation of the accelerator pedal 22 is being performed (Step S105). In this step, it is determined that the depressing operation is being performed on the accelerator pedal 22 if the accelerator depression amount Othr is greater than or equal to a predetermined amount.

When it is determined that the depressing operation is not being performed on the accelerator pedal 22 (step S105: NO), it is determined that the acceleration and the start of the vehicle 10 will not be caused by simultaneous depressing of the brake pedal 17 and the accelerator pedal 22. In this case, an output restriction flag is turned OFF (Step S118) and the process is temporarily terminated.

In contrast, when it is determined that the depressing operation of the accelerator pedal 22 is being performed (Step S105: YES), it is determined whether or not the vehicle is in a slip state (Step S106). In this step, a difference ΔVSO between the wheel speed VSO and the estimated vehicle body speed Vref is computed for each wheel 14. If any one of the differences ΔVSO is greater than or equal to a determination value J1, it is determined that the vehicle 10 is in the slip state. As the above described determination value J1, a value by which it can be precisely determined that any of the wheels 14 is slipped to a degree such that the master pressure estimated value PesPm cannot be computed with high accuracy is obtained in advance on the basis of results of experiments and simulation. In the present embodiment, the determination value J1 corresponds to a fourth determination value. The difference ΔVSO between each wheel speed VSO and the estimated vehicle body speed Vref corresponds to a difference of the rotation speed of two of the wheels 14. Accordingly, it is understood that the process of Step S106 is directed to determination whether or not the vehicle 10 is in the slip state on the basis of the difference of the rotation speed of the two of the wheels 14. When it is determined that the vehicle 10 is in the slip state (Step S106: YES), it is determined that the master pressure estimated value PesPm at this time cannot be computed with high accuracy and that the restriction of the output torque of the internal-combustion engine 11 cannot be performed. In this case, the output restriction flag is turned OFF (Step S118) and the process is temporarily terminated.

The above described output restriction flag operates as follows. When the output restriction flag is turned ON, a signal indicating that it is necessary to restrict the output torque of the internal-combustion engine 11 is supplied to the engine ECU 31. When the engine ECU 31 receives the signal, the engine ECU 31 changes a driving control mode of the internal-combustion engine 11 to a control mode at the time of idling without depending on the accelerator depression amount Othr. Thereby, the output torque of the internal-combustion engine 11 is restricted to be low so that the vehicle 10 is prevented from accelerating or starting against braking force by the depressing operation of the brake pedal 17. In contrast, when the output restriction flag is turned OFF, the signal is not supplied to the engine ECU 31 so that the restriction of the output torque of the internal-combustion engine 11 is not performed. Accordingly, in this step, when the depressing operation of the accelerator pedal 22 is not performed or when the vehicle 10 is in the slip state, the restriction of the output torque of the internal-combustion engine 11 is not performed. In the present embodiment, the processes of step S106 and step S118 correspond to a restriction inhibiting step.

In contrast, when it is determined that the depressing operation is being performed on the accelerator pedal 22 (Step S105: YES), it is determined that the vehicle 10 is not in the slip state (Step S106: NO), the following step is performed since the acceleration and the start of the vehicle 10 may be caused by the simultaneous operation of both of the pedals 17 and 22 and the master pressure estimated value PesPm can be computed with high accuracy.

The driving torque (axle driving torque Taxle) transmitted from the internal-combustion engine 11 to the axle 13 is computed by the following equation on the basis of the engine torque Teng, the gear ratio Rtgear of the automatic transmission 12 computed on the basis of the gear position Pgear, and the gear ratio Rfinal of the final gear provided in the automatic transmission 12 (Step S107).

Taxle=Teng×Rtgear×Rfinal

Then, the axle driving torque Taxle is converted into a value corresponding to the acceleration of the vehicle 10 (driving torque equivalent acceleration Gdrv) by a conversion coefficient Ctg (Step S108). More specifically, the driving torque equivalent acceleration Gdrv (Gdrv=Taxle×Ctg) is computed by multiplying the axle driving torque Taxle by the conversion coefficient Ctg. The conversion coefficient Ctg is a value for converting the driving torque transmitted to the axle into the acceleration of the vehicle 10. The conversion coefficient Ctg is determined on the basis of specifications of the vehicle 10 and is obtained in advance and stored in the brake ECU 32.

Thereafter, as shown in FIG. 5, it is determined whether or not the vehicle 10 is in a stopped state (Step S109). It is determined that the vehicle 10 is in a stopped state if the estimated vehicle body speed Vref is 0 (or almost 0).

When it is determined that the vehicle 10 is in a stopped state (Step S109: YES), the pitching correction value Gp is computed from a computation map on the basis of the above described axle driving torque Taxle (Step S110). In the present embodiment, the relationship between a value by which detection errors of the sensor-detected acceleration G caused by the occurrence of the pitching phenomenon can be precisely corrected (pitching correction value Gp) and the axle driving torque Taxle at the time of the stop of the vehicle is obtained in advance on the basis of results of experiments and simulation and stored in the brake ECU 32 (more specifically, the above described computation map). The greater the axle driving torque Taxle, the greater the computed value of the pitching correction value Gp becomes.

In contrast, when it is determined that the vehicle 10 is not in a stopped state, namely, when the vehicle 10 is running (Step S109: NO), the pitching correction value Gp is computed from the computation map on the basis of the estimated vehicle body acceleration ΔVref (Step S111). In the present embodiment, the relationship between the value by which the detection errors of the sensor-detected acceleration G caused by the occurrence of the pitching phenomenon can be precisely corrected (pitching correction value Gp) and the estimated vehicle body acceleration ΔVref at the time of running of the vehicle is obtained in advance on the basis of results of experiments and simulation and stored in the brake ECU 32 (more specifically, the above described computation map). The greater the absolute value of the estimated vehicle body acceleration ΔVref, the greater the computed value of the pitching correction value Gp becomes. In the present embodiment, the processes of steps S109 to S111 correspond to a correction value computing step.

After the pitching correction value Gp is computed in accordance with the running state of the vehicle 10 as described above, a value (brake equivalent acceleration Gbrk) corresponding to the acceleration generated by the depressing operation of the brake pedal 17 is computed by the following equation on the basis of the sensor-detected acceleration G, the drive torque equivalent acceleration Gdrv, rolling resistance Gk, and the pitching correction value Gp (Step S112).

Gbrk=G−Gdrv−Gk+Gp

As the rolling resistance Gk, a certain value determined by the specifications (specifically, the size and materials) of a standard tire and set for each type of the vehicles is stored in the brake ECU 32 in advance.

Thereafter, a negative pressure correction coefficient Cvc is computed from the computation map on the basis of the booster negative pressure Pv detected by the pressure sensor 37 (Step S113). In the present embodiment, the relationship between the booster negative pressure Pv and a correction value by which the master pressure estimated value PesPm can be computed with high accuracy (negative pressure correction coefficient Cvc) is obtained in advance on the basis of results of experiments and simulation to be stored in the brake ECU 32 (more specifically, the above described computation map). The smaller the booster negative pressure Pv, the greater the computed value of the negative pressure correction coefficient Cvc becomes.

Further, a load correction coefficient Cwe is computed from the computation map on the basis of the estimated value of the weight of the vehicle (load estimated value PesW) (Step S114). In the present embodiment, the relationship between the load estimated value PesW and a correction value by which the master pressure estimated value PesPm can be computed with high accuracy (load correction coefficient Cwe) is obtained in advance on the basis of results of experiments and simulation to be stored in the brake ECU 32 (more specifically, the above described computation map). The greater the load estimated value PesW, the greater the computed value of the load correction coefficient Cwe becomes.

The above described load estimated value PesW is computed through a process (load estimation process) different from the present process and stored in the brake ECU 32 so that the stored value is read out when executing the present process. The step of computing and storing the above described load estimated value PesW in the load estimation process is executed when all of the following conditions are satisfied.
There is no history of computation of the load estimated value PesW in a period from when a driving switch (not shown) is turned on to start driving of the vehicle 10 to when the driving switch is turned off to stop driving of the vehicle 10 (what is called, during a trip).
The depressing operation of the brake pedal 17 is not being performed (specifically, the brake switch 35 is turned off).
The vehicle 10 is running (specifically, the estimated vehicle body speed Vref is greater than or equal to predetermined speed).

Further, computation of the load estimated value PesW is performed as follows. When the sensor-detected acceleration G detected by the acceleration sensor 34 is represented by [a], and the engine torque Teng applied to the vehicle 10 is represented by force [F], a value corresponding to the weight [m] of the vehicle 10, which satisfies an equation of motion [F=ma], is computed as the above described load estimated value PesW. As described above, in the present embodiment, the load estimated value PesW is computed on the basis of the motion equation [F=ma] with high accuracy.

After computing the negative pressure correction coefficient Cvc (Step S113) and the load correction coefficient Cwe (Step S114), the master pressure estimated value PesPm is computed by the following equation on the basis of the brake equivalent acceleration Gbrk, conversion coefficient Cgp, the negative pressure correction coefficient Cvc, and the load correction coefficient Cwe (Step S115).

PesPm=Gbrk×Cgp×Cvc×Cwe

The above described conversion coefficient Cgp is a constant value for converting the acceleration of the vehicle 10 into the depressing force of the brake pedal 17, which is determined on the basis of the specifications of the vehicle 10. The conversion coefficient Cgp is obtained in advance and stored in the brake ECU 32. In the present embodiment, the processes of steps S107, S108, and S112 to S115 correspond to a depressing force estimating step.

Thereafter, it is determined whether or not both of [Condition A] and [Condition B] are satisfied (Step S116).

[Condition A] The accelerator depression amount Othr is greater than or equal to the first determination value α.

[Condition B] The master pressure estimated value PesPm is greater than or equal to the second determination value β.

As the first determination value α and the second determination value β, values are set by which it can be precisely determined that the acceleration and the start of the vehicle 10 may be caused due to simultaneous depressing of the brake pedal 17 and the accelerator pedal 22. These values are obtained in advance on the basis of results of experiments and simulation.

When both of the [Condition A] and [Condition B] are satisfied (Step S116: YES), it is determined that the acceleration and the start of the vehicle 10 due to simultaneous depressing of both of the pedals 17 and 22 may occur (Step S117). In this case, an output restriction flag is turned ON. Thereby, the output torque of the internal-combustion engine 11 is restricted, and the acceleration and the start of the vehicle 10 due to the simultaneous depressing of both of the pedals 17 and 22 are restricted. In the present embodiment, the processes of step S116 and step S117 correspond to a torque restricting step.

In contrast, when at least one of the [Condition A] and the [Condition B] is not satisfied (Step S116: NO), the output restriction flag is turned OFF (Step S118). In this case, the output torque of the internal-combustion engine 11 is not restricted.

Accordingly, the output restriction flag is operated on the basis of the master pressure estimated value PesPm, and then the present step is temporarily terminated.

As described above, the following advantages are obtained according to the present embodiment.

(1) The master pressure estimated value PesPm is computed on the basis of the engine torque Teng computed by the engine ECU 31 and the sensor-detected acceleration G of the vehicle 10 detected by the acceleration sensor 34. That is, the changes in the acceleration of the vehicle 10 by the depressing operation of the brake pedal 17 are determined on the basis of the relationship between the sensor-detected acceleration G of the vehicle 10 detected by the acceleration sensor 34 and the acceleration of the vehicle 10 obtained by the operation of the internal-combustion engine 11 to be determined on the basis of the engine torque Teng. The master pressure estimated value PesPm is computed with high accuracy on the basis of the changes in the acceleration. The restriction of the output of the internal-combustion engine 11 is performed by the brake ECU 32 on the basis of the master pressure estimated value PesPm. Accordingly, the restriction of the output of the internal-combustion engine 11 is precisely performed by determining the simultaneous depressing of the brake pedal 17 and the accelerator pedal 22 on the basis of the determination that the master pressure estimated value PesPm is greater than or equal to the second determination value β and the determination that the accelerator depression amount Othr detected by the accelerator operation amount sensor 33 is greater than or equal to the first determination value α. Accordingly, the acceleration and the start of the vehicle 10 due to the simultaneous depressing of the brake pedal 17 and the accelerator pedal 22 is restricted without providing a sensor for detecting the amount of depressing operation of the brake pedal 17.

(2) The booster negative pressure Pv detected by the pressure sensor 37 is used as one of the estimation parameters for the master pressure estimated value PesPm. Accordingly, the master pressure estimated value PesPm is computed with high accuracy in consideration of the effects by the changes in the booster negative pressure Pv.

(3) The load estimated value PesW is used as one of estimation parameters for the master pressure estimated value PesPm. Accordingly, the master pressure estimated value PesPm is estimated with high accuracy in consideration of the effects by the changes in the weight of the vehicle 10.

(4) When the sensor-detected acceleration G detected by the acceleration sensor 34 is represented by [a], and the engine torque Teng applied to the vehicle 10 is represented by force [F], a value corresponding to the weight [m] of the vehicle 10 that satisfies a motion equation [F=ma] is computed as the load estimated value PesW. Accordingly, the load estimated value PesW is computed on the basis of the motion equation [F=ma] with high accuracy.

(5) Even if a difference is generated between the actual acceleration of the vehicle 10 in the running direction and the sensor-detected acceleration G detected by the acceleration sensor 34 by changes in the posture of the vehicle 10 due to the occurrence of a pitching phenomenon, the master pressure estimated value PesPm is estimated with high accuracy via correction of the pitching correction value Gp in accordance with the changes in the posture of the vehicle 10.

(6) During the running of the vehicle 10, the pitching correction value Gp is computed on the basis of the estimated vehicle body acceleration ΔVref estimated on the basis of the wheel speed VSO detected by the speed sensor 36. Accordingly, the pitching correction value Gp is computed on the basis of the changes in the running speed of the vehicle 10, namely, a value correlated with the changes in the posture of the vehicle 10 due to the pitching phenomenon. Therefore, according to the pitching correction value Gp, the master pressure estimated value PesPm is computed with high accuracy, while restricting reduction of the accuracy of the estimation due to the above described changes in the posture.

(7) During the stop of the vehicle 10, the pitching correction value Gp is computed on the basis of the axle driving torque Taxle computed on the basis of the engine torque Teng. Accordingly, the pitching correction value Gp is computed on the basis of the driving torque transmitted to the axle 13, namely, a value correlated with the changes in the posture of the vehicle 10 due to the pitching phenomenon. Therefore, according to the pitching correction value Gp, the master pressure estimated value PesPm is computed with high accuracy, while restricting the reduction of the accuracy of the estimation due to the above described changes in the posture.

(8) When slip of the vehicle 10 occurs, the accuracy of the estimation of the above described master pressure estimated value PesPm is determined to be low. In this case, it is possible to avoid restriction of the output of the internal-combustion engine 11 even though the master pressure estimated value PesPm is high.

### Second Embodiment

A vehicle control apparatus according to a second embodiment of the present invention will now be described. The differences from the first embodiment will mainly be described. In the present embodiment, the same reference numerals are given to parts that are common with the first embodiment and a detailed description thereof is omitted.

In the first embodiment, when the vehicle 10 is in a slip state, the restriction of the output of the internal-combustion engine 11 by the BOS is inhibited. In contrast, in the present embodiment, even if the vehicle 10 is in a slip state, the restriction of the output of the internal-combustion engine 11 by the BOS is not inhibited (namely, the restriction of the output is permitted) when a difference ΔV between the rotation speed of the drive wheels 14A and the rotation speed of the coasting wheels 14B of the vehicle 10 is greater than or equal to a determination value J2. According to an apparatus of the present embodiment, the acceleration and the start of the vehicle 10 by the simultaneous operation of the brake pedal 17 and the accelerator pedal 22 are reliably restricted. The reason will now be described.

In the vehicle 10, the output torque of the internal-combustion engine 11 is transmitted to only the drive wheels 14A, while the braking force by the depressing operation of the brake pedal 17 is applied to both of the drive wheels 14A and the coasting wheels 14B. Accordingly, when slip occurs at the time of the simultaneous operation of the brake pedal 17 and the accelerator pedal 22, the difference between the rotation speed of the drive wheels 14A and the rotation speed of the coasting wheels 14B becomes greater. The higher the amount of depressing operation of the accelerator pedal 22, the greater the difference of the rotation speeds becomes.

The apparatus according to the present embodiment is configured to utilize the above fact. That is, the accuracy of the estimation of the master pressure estimated value PesPm is low when the vehicle 10 is slipped at the time of the simultaneous depressing of both of the pedals 17 and 22. Even in such a case, the apparatus of the present embodiment observes a great difference between the rotation speed of the drive wheels 14A and the rotation speed of the coasting wheels 14B of the vehicle 10, thereby accurately determines that acceleration and start of the vehicle may be caused. According to such determination, the output of the internal-combustion engine 11 is restricted so that acceleration and start of the vehicle 10 due to simultaneous depressing of both of the pedals 17 and 22 are reliably restricted.

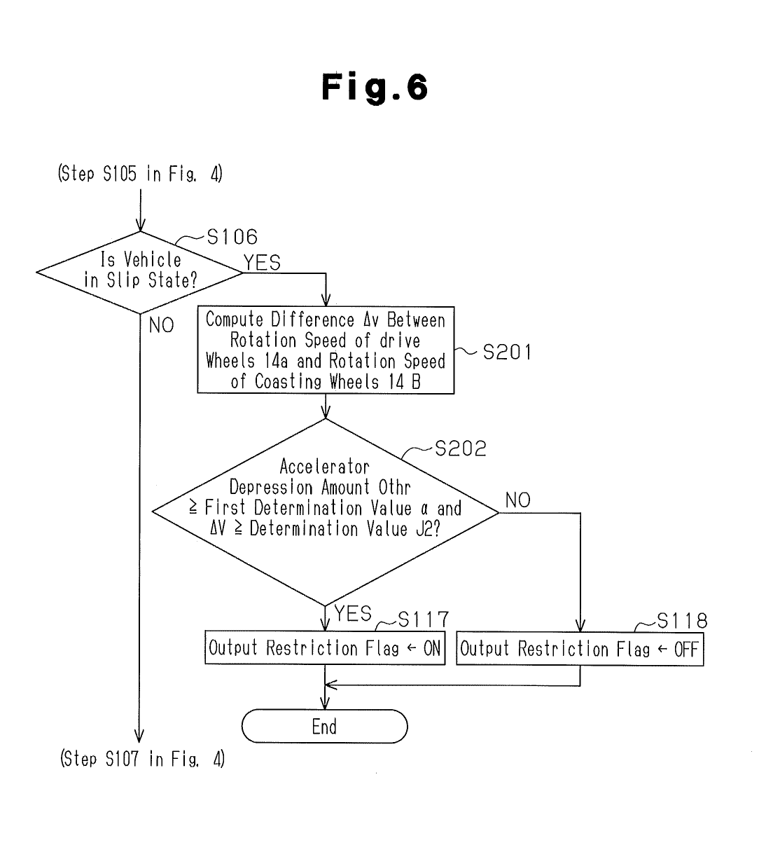

Hereinafter, the torque restriction process according to the present embodiment including the determining process on the basis of the above described difference of the rotation speed will now be described with reference to FIG. 6.

As shown in FIG. 6, when it is determined that the vehicle 10 is in a slip state (Step S106: YES), the difference ΔV between the rotation speed of the drive wheels 14A and the rotation speed of the coasting wheels 14B of the vehicle 10 is computed (Step S201). As the difference ΔV of the rotation speed, specifically, a value obtained by subtracting an average value of the wheel speeds VSO of the two coasting wheels 14B from an average value of the wheel speeds VSO of the two drive wheels 14A is computed. In the present embodiment, the brake ECU 32 functions as a speed difference computation section, which computes the rotation speed difference ΔV.

Thereafter, it is determined whether or not both of the above described [Condition A] and the following [Condition C] are satisfied (Step S202).

[Condition C] The difference ΔV between the rotation speed of the drive wheels 14A and the rotation speed of the coasting wheels 14B is greater than or equal to the determination value J2.

As the determination value J2, a value by which it can be precisely determined that the acceleration and the start of the vehicle 10 may be caused due to simultaneous depressing of both of the pedals 17 and 22 is obtained in advance on the basis of results of experiments and simulation to be stored in the brake ECU 32. In the present embodiment, according to a fact that the above described [Condition C] is satisfied, it can be precisely determined that the rotation speed of the coasting wheels 14B is higher than the rotation speed of the drive wheels 14A due to the simultaneous operation of both of the brake pedal 17 and the accelerator pedal 22 and the difference of the rotation speed is high, namely, the acceleration and the start of the vehicle 10 due to simultaneous operation of the pedals 17 and 22 may be caused. In the present embodiment, the above described determination value J2 functions as a third determination value.

When it is determined that both of the [Condition A] and [Condition C] are satisfied (Step S202: YES), the output restriction flag is turned ON since the acceleration and the start of the vehicle 10 due to the simultaneous depressing of both of the pedals 17 and 22 may occur (Step S117). Thereby, the output torque of the internal-combustion engine 11 is restricted, and the acceleration and the start of the vehicle 10 due to the simultaneous depressing of both of the pedals 17 and 22 are restricted.

In contrast, when at least one of the [Condition A] and the [Condition C] is not satisfied (Step S202: NO), the output restriction flag is turned OFF (Step S118). In this case, it is determined that not only the master pressure estimated value PesPm cannot be computed with high accuracy, but also that the rotation speed difference ΔV is not a value indicating the possibility of acceleration and start of the vehicle 10 due to the simultaneous depressing of both pedals 17 and 22. In this case, the output torque of the internal-combustion engine 11 is not restricted.

Accordingly, the output restriction flag is operated on the basis of the difference ΔV between the rotation speed of the drive wheels 14A and the rotation speed of the coasting wheels 14B, and then the present step is temporarily terminated.

In contrast, when it is determined that the vehicle 10 is not in a slip state (Step S106: NO), the process starting from step S107 is performed (refer to FIGS. 4 and 5) since the master pressure estimated value PesPm at this time can be computed with high accuracy.

As above described, according to the present embodiment, in addition to the advantages as described in the above items (1) to (8), the following advantages as disclosed in items (9) and (10) below are obtained.

(9) Even if the accuracy of the estimation of the master pressure estimated value PesPm is low because of slipping of the vehicle 10 at the time of the simultaneous depressing of the brake pedal 17 and the accelerator pedal 22, it can be accurately determined that the acceleration and the start of the vehicle at this time may be caused due to a great difference between the rotation speed of the drive wheels 14A and the rotation speed of the coasting wheels 14B of the vehicle 10. According to such determination, the output of the internal-combustion engine 11 can be restricted so that the acceleration and the start of the vehicle 10 due to the simultaneous depressing of both of the pedals 17 and 22 can be reliably restricted.

(10) A value obtained by subtracting the rotation speed of the coasting wheels 14B from the rotation speed of the drive wheels 14A is computed as the rotation speed difference ΔV. Accordingly, on the basis of the rotation speed difference ΔV, it can be precisely determined that the rotation speed of the coasting wheels 14B is higher than the rotation speed of the drive wheels 14A due to the simultaneous operation of both of the pedals 17 and 22 and the difference of the rotation speed is high, namely, the acceleration and the start of the vehicle 10 due to the simultaneous operation of both of the pedals 17 and 22 may be caused.

### Third Embodiment

A vehicle control apparatus according to a third embodiment of the present invention will now be described. The differences from the first embodiment will mainly be described. In the present embodiment, the same reference numerals are given to parts that are common with the first embodiment and a detailed description thereof is omitted.

In the first embodiment, the negative pressure correction coefficient Cvc is computed on the basis of the booster negative pressure Pv detected by the pressure sensor 37, and the negative pressure correction coefficient Cvc is used as an estimation parameter for the master pressure estimated value PesPm. In contrast, in the present embodiment, the pressure sensor 37 is not provided. Accordingly, the negative pressure correction coefficient Cvc is not computed, and the master pressure estimated value PesPm is estimated without using the negative pressure correction coefficient Cvc. Further, in the present embodiment, the brake ECU 32 as a change section is configured to change the second determination value β in the above described [Condition B] to be smaller when frequency of performing the depressing operation of the brake pedal 17 detected by the brake switch 35 is greater than or equal to the determination value. With such a configuration, the following advantage is obtained.

As described above, when the depressing operation of the brake pedal 17 is repeatedly performed in a short time and the booster negative pressure is almost lost (substantially the same as the atmospheric air pressure) a situation in which the brake pedal 17 is depressed in the state in which there is almost no assistance by the brake booster 18 is caused. In this case, since the degree of the deceleration of the vehicle 10 with respect to the actual depressing force of the brake pedal 17 becomes less, the master pressure estimated value PesPm becomes a smaller value (value that shows a low pressure) by the degree.

In the present embodiment, a threshold value (the second determination value β) of the [Condition B] determined on the basis of the master pressure estimated value PesPm is changed to be smaller in accordance with the changes in the master pressure estimated value PesPm due to changes in the booster negative pressure. Thereby, when the depressing operation of the brake pedal 17 is repeatedly performed in a short time, namely, when the booster negative pressure is less, the restriction of the output of the internal-combustion engine 11 is permitted in a state in which the master pressure estimated value PesPm is small in comparison to a case in which the booster negative pressure is not less. Accordingly, although the degree of the deceleration of the vehicle 10 at this time becomes small, a condition (specifically [Condition B]) for performing the restriction of the output of the internal-combustion engine 11 can be changed in accordance with the degree so that the restriction of the output of the internal-combustion engine 11 can be reliably performed.

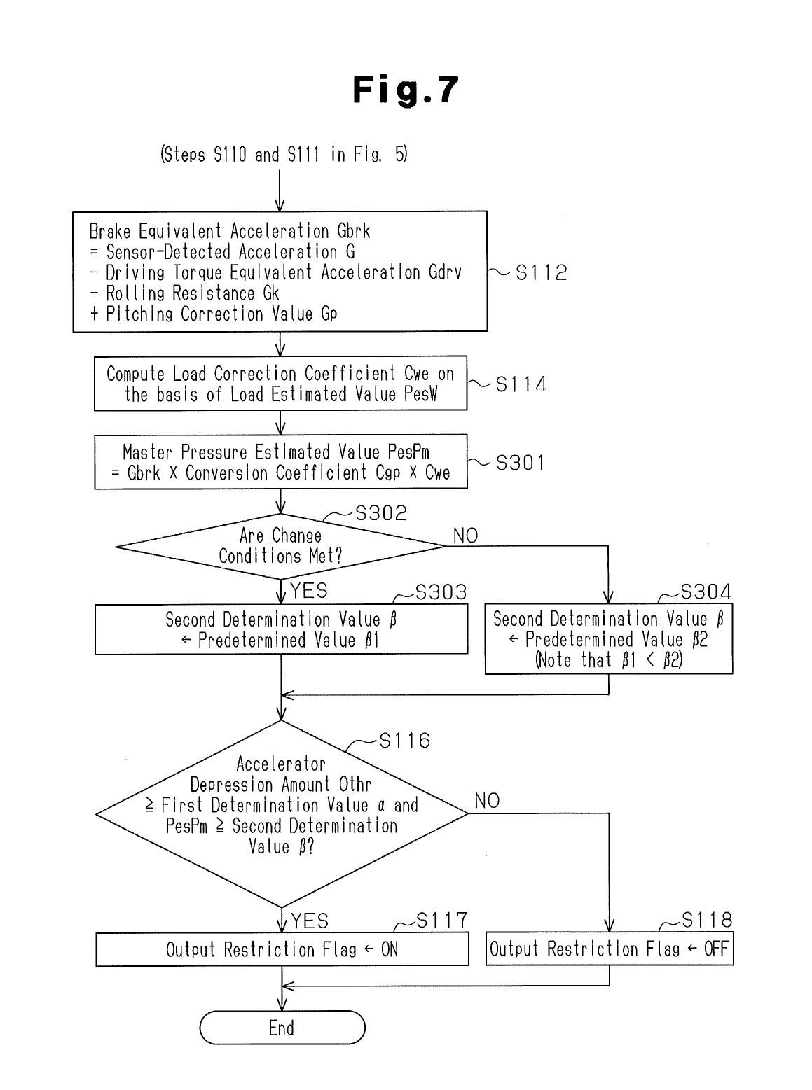

Hereinafter, the torque restriction process of the present embodiment will now be described with reference to FIG. 7.

As shown in FIG. 7, in the present process, the brake equivalent acceleration Gbrk is computed by the following equation on the basis of the above described sensor-detected acceleration G, the drive torque equivalent acceleration Gdrv, the rolling resistance Gk, and the pitching correction value Gp (Step S112).

Gbrk=G−Gdrv−Gk+Gp

Thereafter, the load correction coefficient Cwe is computed on the basis of the load estimated value PesW (Step S114). Then, the master pressure estimated value PesPm is computed by the following equation on the basis of the brake equivalent acceleration Gbrk, the conversion coefficient Cgp, and the load correction coefficient Cwe (Step S301).

PesPm=Gbrk×Cgp×Cwe

Thereafter, it is determined whether or not change conditions for changing the above described second determination value β are met (step S302). Here, it is determined that the change conditions are met according to a fact that the following [Condition D] is satisfied and any of the following [Condition E] to [Condition G] is met.

[Condition D] The accelerator depression amount Othr is greater than or equal to the first determination value α, and an amount of changes in the accelerator depression amount Othr per unit time is less than or equal to a predetermined value.

[Condition E] During a state in which the above described [Condition D] is satisfied is continued, the number of times of operating the brake switch 35 to be turned on is greater than or equal to a predetermined number of times (for example, three times).

[Condition F] During a state in which the above described [Condition D] is satisfied is continued, the brake switch 35 is turned on at intervals less than a certain period (for example, one second).

[Condition G] The lapsed time from when any one of the above described [Condition E] and [Condition F] is satisfied in a state in which the above described [Condition D] is satisfied is less than a certain period.

When the above described change conditions are met (Step S302: YES), it is determined that the booster negative pressure becomes small due to the high frequency of the depressing operation of the brake pedal 17 so that a predetermined value β1 is set as the second determination value β (Step S303). In the present embodiment, it is determined that the frequency of performing the depressing operation of the brake pedal 17 is greater than or equal to the third determination value according to a fact that the [Condition E] or the [Condition F] is satisfied. As the predetermined value β1, a value by which it can be precisely determined that the acceleration and the start of the vehicle 10 may occur due to the simultaneous depressing of the brake pedal 17 and the accelerator pedal 22 through the above described [Condition B], which value is suitable for a situation in which the booster negative pressure is small, is obtained in advance on the basis of results of experiments and simulation to be stored in the brake ECU 32.

In contrast, when the above described change conditions are not met (Step S302: NO), it is determined that possibility that the booster negative pressure is small is low so that a predetermined value β2 is set as the second determination value β (Step S304). As the predetermined value β2, a value is used by which it can be precisely determined that the acceleration and the start of the vehicle 10 may occur due to the simultaneous depressing of the brake pedal 17 and the accelerator pedal 22 through the above described [Condition B], which value is suitable for a situation in which the booster negative pressure is not small. The value is obtained in advance on the basis of results of experiments and simulation to be stored in the brake ECU 32. As the predetermined value β2, a value greater than the above described predetermined value β1 is set.

After the second determination value β is set as described above, it is determined whether or not both of the above described [Condition A] and [Condition B] are satisfied (Step S116).

When both of the [Condition A] and [Condition B] are satisfied (Step S116: YES), an output restriction flag is turned ON since the acceleration and the start of the vehicle 10 due to the simultaneous depressing of the pedals 17 and 22 may occur (Step S117). Thereby, the output torque of the internal-combustion engine 11 is restricted, and the acceleration and the start of the vehicle 10 due to the simultaneous depressing of the pedals 17 and 22 are restricted.

In contrast, when at least one of the [Condition A] and the [Condition B] is not satisfied (Step S116: NO), the output restriction flag is turned OFF (Step S118). In this case, the output torque of the internal-combustion engine 11 is not restricted.

Accordingly, the output restriction flag is operated on the basis of the master pressure estimated value PesPm, and then the present step is temporarily terminated.

As above described, according to the present embodiment, in addition to the advantages as described in the above items (1), (3) and (4) to (8), the following advantage as described in item (11) below is obtained.

(11) The second determination value β in the above described [Condition B] is changed to be smaller when the frequency of performing the depressing operation of the brake pedal 17 detected by the brake switch 35 is greater than or equal to the determination value. Accordingly, the threshold value (the second determination value β) of the [Condition B]determined on the basis of the master pressure estimated value PesPm is changed to be smaller in accordance with the changes in the master pressure estimated value PesPm due to the changes in the booster negative pressure. Therefore, the restriction of the output of the internal-combustion engine 11 can be reliably performed.

### Further Embodiments

The above described embodiments may be modified as follows.

In each embodiment, as the method of computing the weight (specifically, the load estimated value PesW) of the vehicle 10, not only the computation method by the motion equation but also any computation methods may be adopted. As the computation parameters for computing the weight of the vehicle, for example, the number of passengers determined on the basis of signals from seat sensors and seatbelt switches, fuel residue in a fuel tank detected by a fuel residue sensor, and a vehicle height detected by a vehicle height sensor may be adopted. In a case where these computation parameters are adopted, when the number of passengers is greater, when the residue of the fuel is greater, or when the vehicle height is lower, a greater value may be computed as the weight of the vehicle 10.

In each embodiment, the load correction coefficient Cwe may be computed on the basis of a predetermined equation as an alternative to the computation through the map computation.

In each embodiment, the second determination value β of the [Condition B] may be set changeable in accordance with the load estimated value PesW as an alternative to using the load estimated value PesW as the estimation parameter for the master pressure estimated value PesPm. In such a configuration, the greater the load estimated value PesW is, the smaller the second determination value β may be set. According to such a configuration, even if the brake pedal 17 is operated by the same depressing force and the weight of the vehicle is greater so that the degree of the deceleration of the vehicle 10 is small and the master pressure estimated value PesPm is small, the second determination value β is changed in accordance with changes in the master pressure estimated value PesPm. Therefore, the acceleration and the start of the vehicle 10 by the simultaneous operation of the brake pedal 17 and the accelerator pedal 22 can be reliably restricted.

In each embodiment, a configuration of computing the load estimated value PesW and a configuration for using the load estimated value PesW as the estimation parameter for the master pressure estimated value PesPm may be omitted.

In the first and the second embodiments, the negative pressure correction coefficient Cvc may be computed on the basis of an index value of a master cylinder pressure as an alternative to computing the negative pressure correction coefficient Cvc on the basis of the booster negative pressure Pv detected by the pressure sensor 37. As the index value of the master cylinder pressure, for example, timing of depressing operation of the brake pedal 17 detected by the brake switch 35, continuation time of depressing operation of the brake pedal 17, and lapsed time from when the depressing of the brake pedal 17 is released may be adopted.

In the first and the second embodiments, the negative pressure correction coefficient Cvc may be computed on the basis of a predetermined equation as an alternative to the computation through the map computation.

In the first and the second embodiments, the second determination value β of the [Condition B] may be set to be changeable in accordance with the booster negative pressure Pv as an alternative to using the booster negative pressure Pv as the estimation parameter for the master pressure estimated value PesPm. In such a configuration, the smaller the booster negative pressure Pv is, namely the smaller the difference between the pressure in the constant-pressure chamber 23 of the brake booster 18 and the atmospheric air pressure is, a smaller value may be set as the second determination value β. According to such a configuration, even if the brake pedal 17 is operated by the same depressing force and the booster negative pressure Pv is smaller so that the degree of the deceleration of the vehicle 10 is small and the master pressure estimated value PesPm is small, the second determination value β may be changed in accordance with the changes in the master pressure estimated value PesPm. Therefore, the acceleration and the start of the vehicle 10 by the simultaneous operation of the brake pedal 17 and the accelerator pedal 22 can be reliably restricted.

The first and the second embodiments may be structured without the pressure sensor 37 and the configuration for using the booster negative pressure Pv detected by the pressure sensor 37 as the estimation parameter for the master pressure estimated value PesPm.

The vehicle control apparatus according to each embodiment may be applied to a rear drive vehicle, in which the front wheels 14 function as coasting wheels, to which the output torque of the internal-combustion engine 11 is not transmitted, and the rear wheels 14 function as drive wheels, to which the output torque is transmitted.

The vehicle control apparatus of the first and the third embodiments may also be applied to a vehicle such as a four-wheel-drive vehicle, in which all the wheels are drive wheels.

In each embodiment, the method of determining that the vehicle 10 is in the slip state may be optionally changed. As the conditions for determining that the vehicle 10 is in the slip state, for example, a condition [a difference between a maximum value and a minimum value of the wheel speed VSO of the wheels 14 is greater than or equal to a predetermined value] and a condition [a difference between an average value of the wheel speed VSO of the wheels 14 and the wheel speed VSO of any of the wheels 14 is greater than or equal to a predetermined value] may be set. Further, the method is not limited to the method for determining the slip state on the basis of the wheel speed VSO detected by the speed sensor 36. It is also possible to determine the slip state on the basis of relationship between the gear position Pgear of the automatic transmission 12 and the estimated vehicle body speed Vref.

In the second embodiment, the change conditions may be optionally changed as long as it can be determined that the frequency of performing the depressing operation of the brake pedal is high at the time of the simultaneous depressing of the brake pedal 17 and the accelerator pedal 22. For example, as an alternative to the above described [Condition D], a condition [The accelerator depression amount Othr is greater than or equal to a first determination value α] may be set. Further, the [Condition G] may be omitted or either the [Condition E] or the [Conditions F] may be omitted.

In the first and the third embodiments, a step (process in Step S106 as shown in FIG. 4) of inhibiting the restriction of the output of the internal-combustion engine 11 when the vehicle 10 is in the slip state may be omitted.

The vehicle control apparatus of each embodiment may be applied to a vehicle that adopts an acceleration sensor with two detection axes as long as the acceleration sensor is attached to the vehicle so that the detection axes of the acceleration sensor corresponds to a direction in parallel with a road surface when the vehicle is stopped on a flat road.

In each embodiment, as an alternative to computing the estimated vehicle body acceleration ΔVref on the basis of the wheel speed VSO, the rotation speed of the axle 13 is detected to compute the estimated vehicle body acceleration on the basis of an obtained detection value.

In each embodiment, as an alternative to using a value received from the engine ECU 31 as the engine torque Teng, the engine torque may be computed by the brake ECU 32 on the basis of the driving state (specifically, the accelerator depression amount Othr, rotation speed of the engine, an amount of intake air, and the like) of the vehicle 10 to be used.

In each embodiment, the pitching correction value Gp may be computed on the basis of a predetermined equation as an alternative to the computation through the map computation.

In each embodiment, a posture angle sensor for detecting a posture angle of the vehicle 10 and a vehicle height sensor for detecting a vehicle height may be provided to detect changes in the posture of the vehicle 10 on the basis of detection signals obtained from the sensors to compute the pitching correction value Gp on the basis of an obtained detection value.

In each embodiment, the pitching correction value Gp may be computed only at a time when the vehicle is stopped or when the vehicle is running.

In each embodiment, a step of computing the pitching correction value Gp and a configuration for using the pitching correction value Gp as the estimation parameter for the master pressure estimated value PesPm may be omitted. In this case, a step of computing the estimated vehicle body acceleration ΔVref may be omitted as well.

The configuration of the second embodiment and the configuration of the third embodiment may be combined with each other to be performed.

According to each embodiment, the output torque of the internal-combustion engine 11 is restricted by changing the operation control of the internal-combustion engine 11 to the control mode at the time of the idling operation. As an alternative to this, an upper limit may be set for the output torque of the internal-combustion engine 11, or the operations (specifically, fuel injection and ignition operation) of the internal-combustion engine 11 may be stopped. Further, as an alternative to restricting the output torque of the internal-combustion engine 11, the automatic transmission 12 may be set in a neutral state. In short, the driving torque transmitted from the internal-combustion engine 11 to the axle 13 of the vehicle 10 is restricted so that the acceleration and the start of the vehicle 10 by the simultaneous operation of the brake pedal 17 and the accelerator pedal 22 are reliably restricted.

In each embodiment, as an alternative to computing the estimated vehicle body acceleration ΔVref on the basis of the wheel speed VSO, the rotation speed of the axle 13 is detected as the estimated vehicle body acceleration.

In each embodiment, as an alternative to computing the master pressure estimated value PesPm, an estimated value of the depressing force of the brake pedal 17 may be computed. In short, an index value of the depressing force of the brake pedal 17 or the depressing force may be estimated and simultaneous depressing of the brake pedal 17 and the accelerator pedal 22 may be determined on the basis of an estimated value (brake depressing force estimated value).

1. A vehicle control apparatus applied to a vehicle including an internal-combustion engine as a driving source, an acceleration sensor, which detects vehicle acceleration, and an accelerator operation amount sensor, which detects an amount of a depressing operation of an accelerator pedal, the vehicle control apparatus comprising:
an output computing section, which computes an output torque of the internal-combustion engine;
a depressing force estimating section, which estimates a force of a depressing operation of a brake pedal of the vehicle, on the basis of the vehicle acceleration detected by the acceleration sensor and the output torque computed by the output computing section; and
a torque restricting section, which restricts a driving torque transmitted from the internal-combustion engine to an axle of the vehicle when the amount of the depressing operation of the accelerator pedal detected by the accelerator operation amount sensor is greater than or equal to a first determination value and the force of the depressing operation of the brake pedal estimated by the depressing force estimating section is greater than or equal to a second determination value.

2. The vehicle control apparatus according to claim 1, wherein
the vehicle includes a brake booster, which assists the depressing operation of the brake pedal by a booster negative pressure generated using an intake air negative pressure produced by the internal-combustion engine, and
the depressing force estimating section estimates the force of the depressing operation of the brake pedal using the booster negative pressure as an estimation parameter.

3. The vehicle control apparatus according to claim 1, wherein
the vehicle includes a brake switch, which detects presence or absence of the depressing operation of the brake pedal, and
the vehicle control apparatus further includes a changing section, which changes the second determination value to be smaller when a frequency of performing the depressing operation of the brake pedal detected by the brake switch is greater than or equal to a third determination value.

4. The vehicle control apparatus according to claim 1, wherein
the depressing force estimating section estimates the force of the depressing operation of the brake pedal using the weight of the vehicle as an estimation parameter.

5. The vehicle control apparatus according to claim 2, wherein
the vehicle includes a pressure sensor, which detects the booster negative pressure, and
the depressing force estimating section uses the booster negative pressure detected by the pressure sensor as the estimation parameter.

6. The vehicle control apparatus according to claim 4, further comprising a weight computing section, which computes the weight of the vehicle on the basis of the vehicle acceleration detected by the acceleration sensor and the output torque computed by the output computing section,
wherein the depressing force estimating section uses the weight computed by the weight computing section as the estimation parameter.

7. The vehicle control apparatus according to claim 1, further comprising a correction value computing section, which computes a pitching correction value in accordance with changes in the posture of the vehicle due to a pitching phenomenon,
wherein the depressing force estimating section estimates the force of the depressing operation of the brake pedal on the basis of, in addition to the vehicle acceleration and the output torque, the pitching correction value computed by the correction value computing section.

8. The vehicle control apparatus according to claim 7, wherein
the vehicle includes a speed sensor, which detects a running speed of the vehicle, and
the correction value computing section computes the pitching correction value on the basis of changes in the running speed of the vehicle detected by the speed sensor during running of the vehicle.

9. The vehicle control apparatus according to claim 8, wherein the correction value computing section computes the vehicle acceleration on the basis of the running speed of the vehicle detected by the speed sensor and uses the acceleration as the changes in the running speed.

10. The vehicle control apparatus according to claim 7, wherein the correction value computing section computes the pitching correction value on the basis of the driving torque transmitted to the axle during stop of the vehicle.

11. The vehicle control apparatus according to claim 10, wherein the correction value computing section computes the driving torque on the basis of the output torque computed by the output computing section.

12. The vehicle control apparatus according to claim 1, further comprising a restriction inhibiting section, which determines whether or not a slip of the vehicle has been generated and inhibits restriction of the driving torque by the torque restricting section when determining that the slip has been generated.

13. The vehicle control apparatus according to claim 12, wherein
the vehicle includes a drive wheel to which the output torque of the internal-combustion engine is transmitted and a coasting wheel to which the output torque is not transmitted,
the vehicle control apparatus includes a speed difference computing section, which computes a difference of rotation speed of the drive wheel and rotation speed of the coasting wheel, and
the restriction inhibiting section permits the restriction of the driving torque by the torque restricting section when the difference of the rotation speed computed by the speed difference computing section is greater than or equal to a third determination value.

14. The vehicle control apparatus according to claim 13, wherein the speed difference computing section computes a value obtained by subtracting the rotation speed of the coasting wheel from the rotation speed of the drive wheel as the difference of the rotation speed.

15. The vehicle control apparatus according to claim 12, wherein the restriction inhibiting section determines that the slip has been generated when a difference of rotation speed of two wheels of the vehicle is greater than or equal to a fourth determination value.

16. A method for controlling a vehicle including an internal-combustion engine as a driving source, an acceleration sensor, which detects vehicle acceleration, and an accelerator operation amount sensor, which detects an amount of a depressing operation of an accelerator pedal, the method comprising the steps of:
computing an output torque of the internal-combustion engine;
estimating a force of a depressing operation of a brake pedal of the vehicle on the basis of the vehicle acceleration detected by the acceleration sensor and the output torque computed by the step of computing the output torque; and
restricting a driving torque transmitted from the internal-combustion engine to an axle of the vehicle when the amount of the depressing operation of the accelerator pedal detected by the accelerator operation amount sensor is greater than or equal to a first determination value and the force of the depressing operation of the brake pedal estimated in the step of estimating the force of the depressing operation of the brake pedal is greater than or equal to a second determination value.
